(19) United States
(12) Patent Application Publication
(10) Pub. No.: US 2003/0115415 A1
(43) Pub. Date: Jun. 19, 2003

(54) Portable memory device

(76) Inventors: Roy Want, Los Altos, CA (US); James Kardach, Saratoga, CA (US); Graham D. Kirby, San Jose, CA (US); Trevor A. Pering, Mountain View, CA (US); Steven Swanson, Seattle, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/025,266

(22) Filed: Dec. 18, 2001

(51) Int. Cl. G06F 12/00; G06F 12/14

(52) U.S. Cl. 711/115

(57) ABSTRACT

A method and device is provided for communicating with an access device. The device includes a wireless communications module to communicate with the access device in a wireless fashion, a data storage module to store bulk data, and a controller connected to the communication module and to the data storage module. The controller controls storage of data in the data storage module and retrieval of data from the data storage module in response to requests from a user via the access device. The device may function as a personal server which, for example, communicates with an access device (e.g., PC, PDA, cellular telephone, or the like) using Bluetooth technology. As Bluetooth is a universally accepted communication standard, a variety of different access devices, or any one particular preferred interface, in proximity to the user may be used to define a personal computing environment.

### FIELD OF THE INVENTION

The present invention relates generally to portable computer devices. In particular, the invention relates to a portable memory device for communicating with an access device.

### BACKGROUND OF THE INVENTION

A large number of portable computer devices are available in the market place. Typical examples of these devices are personal digital assistants (PDAs), personal computers (PCs), cellular telephones, portable audio players (e.g., MP3 players), digital watches, or the like. Typically, these devices all have different computing capabilities and a single user typically has two or more of these devices which are usually used independently to perform different tasks. The result is that a user has data stored in several different sources and thus all the user's data is not always readily at hand. Further, due to the low form factor of some portable devices, their user interfaces may be rather limited and circumstances may arise where the user has access to a more convenient access device with a better user interface but needs to access data on the portable device. For the purposes of this specification, the term “access device” should be interpreted broadly to include any man/machine interface that a user may interact with irrespective of its processing capabilities.

### BRIEF DESCRIPTION OF THE DRAWINGS

The invention is now described, by way of non-limiting example, with reference to the accompanying diagrammatic drawings.

In the Drawings,

FIG. 1 shows a schematic block diagram of a data processing system in accordance to the invention;

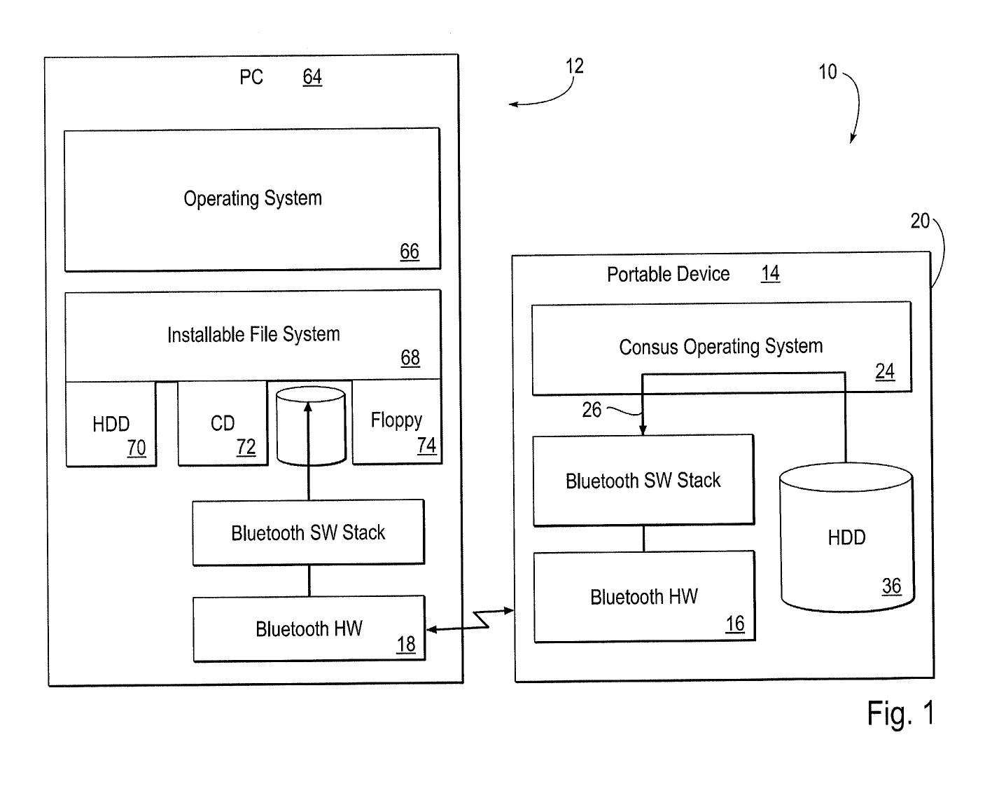

FIG. 2 shows a schematic block diagram of a portable memory device, also in accordance to the invention, for use in the system of FIG. 1;

FIG. 3 shows schematic representation of various states or modes of operation of the portable memory device;

FIG. 4 shows various different access devices which, in combination with the portable memory device, support a personal computing environment; and

FIG. 5 shows various states or modes of operation of a Bluetooth transceiver of the portable memory device of FIG. 2.

### DETAILED DESCRIPTION

Referring to the drawings, reference numeral 10 generally indicates a data processing system in accordance with the invention. The system 10 includes an access device 12 and a portable memory device 14, also in accordance to the invention. As described in more detail below, the portable memory device 14 defines a personal server, which includes a wireless communication module 16 for communicating with a wireless communication interface 18 of the access device 12. Accordingly, a user may carry the portable memory device 14 on his or her person and, when in proximity to the access device 12, use the access device 12 to execute functions which store and retrieve data on the portable memory device 14. The device 14 may thus function as a personal server which, in a wireless fashion, receives data from, and serves data to, any one of a plurality of access devices which are within the proximity of the user.

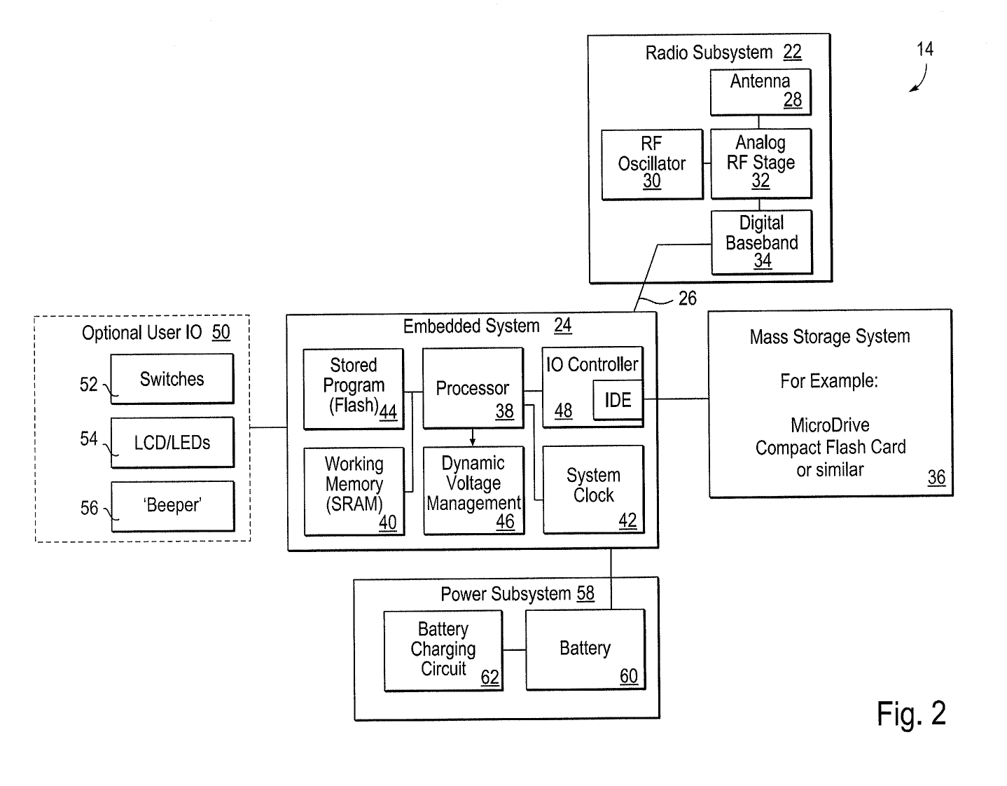

The device 14 preferably includes a compact housing 20 which is shaped and dimensioned so that it is suitable to be carried by a person in a convenient manner. The device 14 further includes an RF transceiver such as a Bluetooth (wireless standard IEEE 802.15)transceiver 22 (see FIG. 2) which defines the wireless communication module 16, and a controller 24 which is connected to, and communicates with, the Bluetooth transceiver 22 via a hardwired communication link 26. The Bluetooth transceiver 22 is typically a conventional Bluetooth transceiver such as that available from Intel™ (e.g., an Intel™ Ambler module) and, accordingly, the communication link 26 may be an RS-232 interface or USB connection. As can been seen from FIG. 2, the Bluetooth transceiver 22 includes an antenna 28, an RF oscillator 30, an analog RF stage 32, and a digital base-band component 34. Although, in the embodiment depicted in the drawings, the wireless communication module 16 is in a form of the Bluetooth transceiver 22, it is to be appreciated that any wireless communication module which communicates using standardized communication protocols, RF techniques and which has a limited range, can be used. Accordingly, 802.11b or 802.11a technology or any other universally accepted communication protocol can be used. However, these 802.11b and 802.11a technologies tend to have a range which is an excess of the preferred range of the device 14 and, accordingly, its power consumption tends to be excessive for a small battery provided device.

The device 14 includes a data storage module 36, which forms a mass data storage or bulk data storage module in which objects or information are stored and accessed via the access device 12. In certain embodiments of the invention, the data storage module 36 forms an integral part of the device 14. However, in other embodiments of the invention, the device 14 may include a releasable connection arrangement for releasably connecting the device 14 to the data storage module 36. In these embodiments, various different mass storage devices may, in combination with the device 14, define a mobile personal server which can form the basic component of a person's computing environment.

The data storage module 36 may be in the form of semiconductor memory (e.g., FLASH, DRAM, SRAM or the like), a magnetic memory (hard disk drive, floppy disk drive, or the like) or an optical memory device (e.g., a CD ROM drive). Thus, the data storage module 36 may be a conventional bulk storage data module which is intergraded or interfaced in a unique and inventive manner using the wireless communication module 16 so that the access device 12 may be used by a user to access data in the data storage module 36. Accordingly, the portable memory device 14 can function as a standalone storage unit or server which is configured primarily to communicate via a wireless link with an access device by which a user can access the data stored in the portable device 14. In certain embodiments, the portable device 14 has a basic user interface which provides a backup or secondary user interface, for example, when the device 14 is not in proximity to a preferred access device. Typically, the device 14 communicates exclusively with any one of a variety of access devices in proximity to the device 14.

The controller 24 is typically in the form of an embedded system including a processor 38, working memory (typically SRAM) 40, a system clock 42, flash memory 44 (which typically stores an operating program for the device 14), and a dynamic voltage management circuit (DVM circuit) 46. Further, the controller 24 includes an input/output (I/O) controller 48 for controlling operation the data storage module 36. It will be appreciated that the type of I/O controller 48 included in the device 14, is chosen to suit the type of data storage module 36 used by the device 14. For example, if the data storage module 36 is a compact flash card, the I/O controller 48 would be configured to read a flash card. Likewise, if the data storage module 36 is a micro drive, then the I/O controller 48 would be configured to read a micro drive.

A basic optional user interface 50 is provided to perform certain diagnostic and programming functions on the device 14. For example, the optional user interface 50 may include switches 52, a display 54 in the form of an LCD display or LEDs, and an audio source 56. It is important to appreciate that the optional user interface 50 could be used to access the data in the storage module 36, however, its main use is merely to provide an indication to a user of various states of the device 14. For example, the display 54 may be used to indicate a low power condition or provide an indication to a user when the device 14 is in communication with an access device. The audio source 56 may be used to indicate a low power condition. As mentioned above, the device 14 is portable and functions as a personal server and, accordingly, it includes its own dedicated power source 58. The power source 58 includes a rechargeable battery 60 and battery charging circuitry 62 for changing the battery 60. Preferably, the battery 60 is substantially similar to a cellular telephone battery. The display allows the device 14 to form a self-contained functional unit when not used in conjunction with the access device 12.

In certain embodiments, the user interface 50 includes a thumb-wheel which controls a pointer arrangement on the access device 12 or the display 54. Typically, the thumb-wheel is used to select functions, applications, or commands in a menu driven fashion without needing to gain access to a keyboard. For example, when the access device 12 is behind a glass window of a store front, the thumb-wheel may be used to interact with the device 14 in a menu driver fashion. When use of the access device 12 is not available or required by a user, the display 54, which is preferably an LCD display panel, may be used to interact with the device 12. The LCD display provides an impoverished interface that is used by the user when there are not other viable choices in the locality or the data to be read is of an extremely covert nature.

Standard wireless communication technologies such as Bluetooth and 802.11b are fast becoming universally accepted communication technologies. Accordingly, a variety of different electronic devices (e.g., cellular telephones, PCs, PDAs, MP3 players, or the like) may be fitted with these wireless communication interfaces 18. Thus, the processing and display capabilities of the access device 12 may vary from device to device and, by merely coming into proximity of any one of these devices, the portable device 14 may interface with any one of these devices and define a server which serves data to the device which then defines the access device 12. For example, the portable device 14 may store MP3 music files or the like and, when in proximity to a headset including the wireless communication interface 16, the user may then listen to music. However, when the user wishes to perform other computing functions, and enters the proximity of a personal computer (PC) 64 which includes a wireless communication interface 18, the device 14 can run application software and use the PC 64 as an access device. Thus, the PC 64 may include an operating system 66, a resident or installed file system 68 connected to a hard disk drive 70, a CD reader 72 and a floppy disk drive 74.

When the access device 12 is a relatively sophisticated access device such as the PC 64, the controller 24 need not perform high-level processing thereby to reduce power consumption of the device 14. Thus, depending on the type of access device 12 in proximity to the device 14, the processor 38 may adjust its level of processing and thus adjust its power consumption accordingly. For example, when in proximity to the PC 64, the processor 38 would operate in a first active mode of operation, in which it minimizes its processing capabilities and the controller 24 would primarily retrieve and store data in the data storage module 36. Typically, under these circumstances, the application software would run on the PC 64. The device 14 may then function as a personal server which serves content or data to the access device. However, in other circumstances, the access device 12 may be a thin client-type device, which includes basically a display and keyboard only and lacks processing power. In these circumstances, the processor 38 operates in a second active mode in which it has higher processing capabilities. In the second mode, applications run on the device 14 and data may be communicated via the wireless communication module 16 to the access device 12 for display. Thus, the level of processing, and thus the active mode of operation of the processor 38, within the portable device 14 may vary dependent upon the complexity of the access device 12 which is in proximity to the portable device 14. In addition or instead, the clock frequency of the processor 38 may be adjusted in different modes of operation, e.g. the clock frequency may be decreased in the first active mode thereby to reduce the power consumption of the device 14.

For example, when the controller 24 has enhanced computing capacity, access to the portable memory device 14 may be provided via a web page served to the access device 12. Thus, the access device 12 may display HTML menus under control of the controller 24 in a wireless fashion. The device 14 may optionally use an Internet browser platform so that standardized client infrastructure may be used as an access device and, accordingly, extensive software updates to existing access devices may be avoided and existing stable and trusted environments may be used.

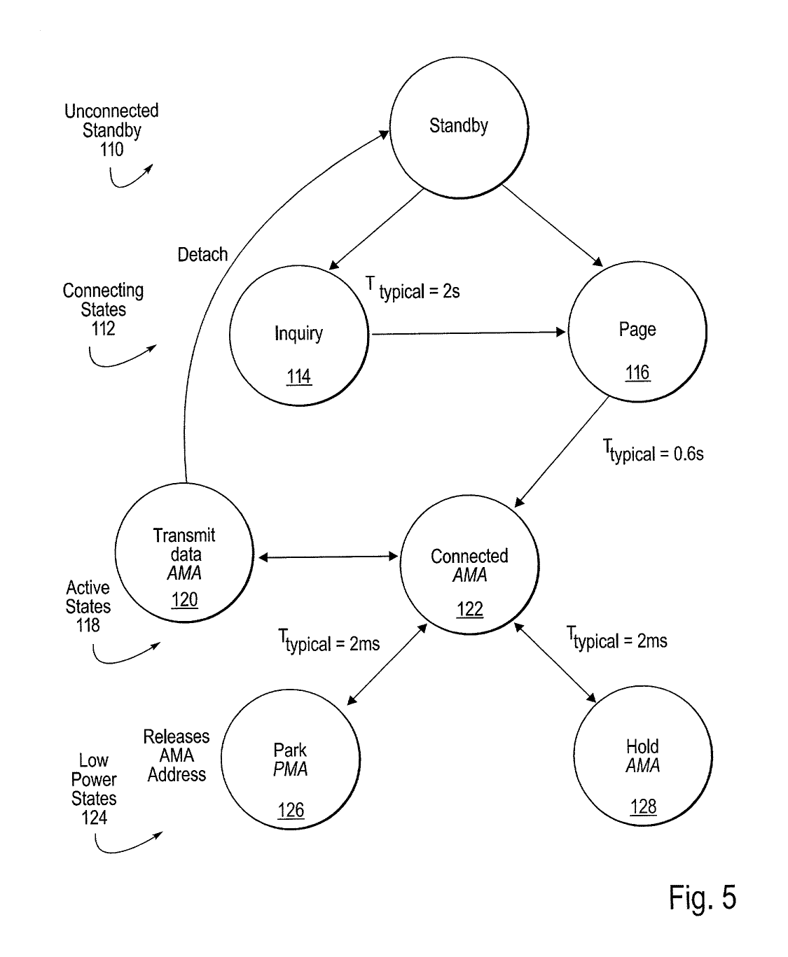

As the device 14 is intended primarily to be portable, or attached to a portable device, it is powered by the battery 60. The device 14 is configured to operate independently of an external power source as a fully self-contained unit. The device 14 may also be placed at a location or access point where no power is provided or carried by a person and, accordingly, it is preferable that power consumed by the device 14 is thus minimized. Accordingly, the device 14 includes a digital voltage management (DVM) circuit 46 configured to control the power dissipated by the controller 24. In particular, the DVM circuit 46 is arranged to reduce the voltage supplied to the controller 24 and thereby reduce the power it consumes when enhanced processing capabilities are not required. Likewise, the Bluetooth transceiver 22 may be reduced to a mode or state of operation (see FIG. 5) in which less power is consumed through commands applied to its host control interface (HCI).

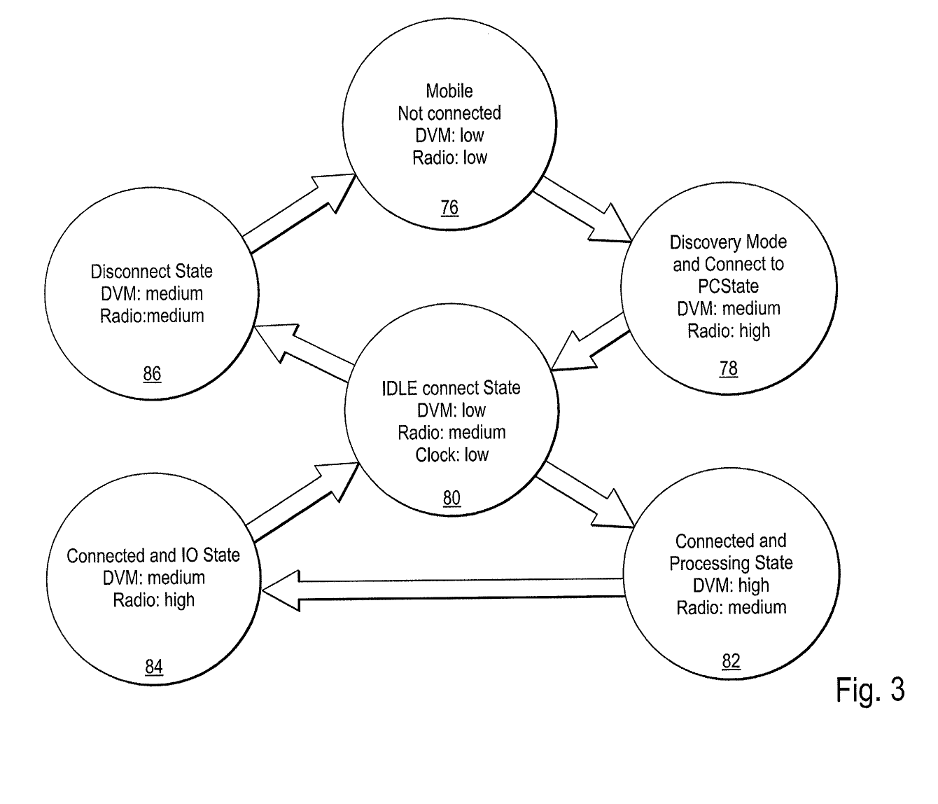

Examples of various modes or states of operation of the portable device 14 are shown in FIG. 3. When the bearer of the device 14 is not in proximity to an access device 12, and the access device is thus not being used by the device 14, the device 14 enters a standby mode or dormant state 76, in which the DVM circuit 46 supplies a low voltage to the processor 38 thereby reducing the power consumed by the portable device 14. However, when the device 14 is in proximity to a suitably configured access device 12, the device 14 enters a discovery mode of operation 78 in which it establishes a connection with the access device 12 in an automated and wireless fashion. In this mode of operation, the DVM circuit 46 supplies a medium or intermediate level of voltage to the processor 38 and the Bluetooth transceiver 22 is in a high state. Once the connection or communication link between the access device 12 and the portable device 14 has been established, and the device 14 is awaiting user instructions, the device 14 enters into an idle state 80 in which the DVM circuit 46 supplies a low voltage level to the processor 38 and the Bluetooth transceiver 22 is in its medium state of operation.

When the device 14 processes data, it enters a connect and processing state 82 in which the DVM circuit 46 supplies a high level of voltage to the processor 38 for enhanced performance, and the Bluetooth transceiver 22 is in its medium state as this mode of operation is not communication intensive. However, once the device 14 has processed the data, and communication thereof to the access device 12 is required, the Bluetooth transceiver 22 is in its high state for enhanced communication with the access device 12 in its connected and I/O state 84. The processor 38 then reverts to a reduced level of activity in which the DVM circuit 46 supplies a medium level of voltage to the processor 38. Once the communication or serving of the data to the access device 12 is completed, the device 14 then reverts to its idle state 80 wherein it awaits further user requests. Dependent upon whether or not there are any further user requests, the device 14 may re-enter the connect and processing state 82, or enter a disconnect state 86. The disconnect state 86 is entered upon request from a user or when a user leaves the proximity of the access device 12. As the portable device 14 functions as a server, all data and results of processing are stored on the device 14 itself, and when communication is lost between the device 14 and an access device 12 no data is lost.

It is to be appreciated that the various states or modes of operation of the Bluetooth transceiver 22 are dependent upon the actual design specifics of its circuitry. For example, FIG. 5 shows a more detailed diagram of various different states entered into by a conventional Bluetooth transceiver. The different states or modes of operation include an unconnected standby state 110, connected states 112 (including an inquiry state 114 and a page state 116) active states 118 (including a transmit data state 120 and a connected state 122), and low power states 124 (including a park state 126 and a hold state 128). Irrespective of the type of Bluetooth transceiver 22, it is configured to operate in such a fashion so that its power consumption is reduced as much as possible.

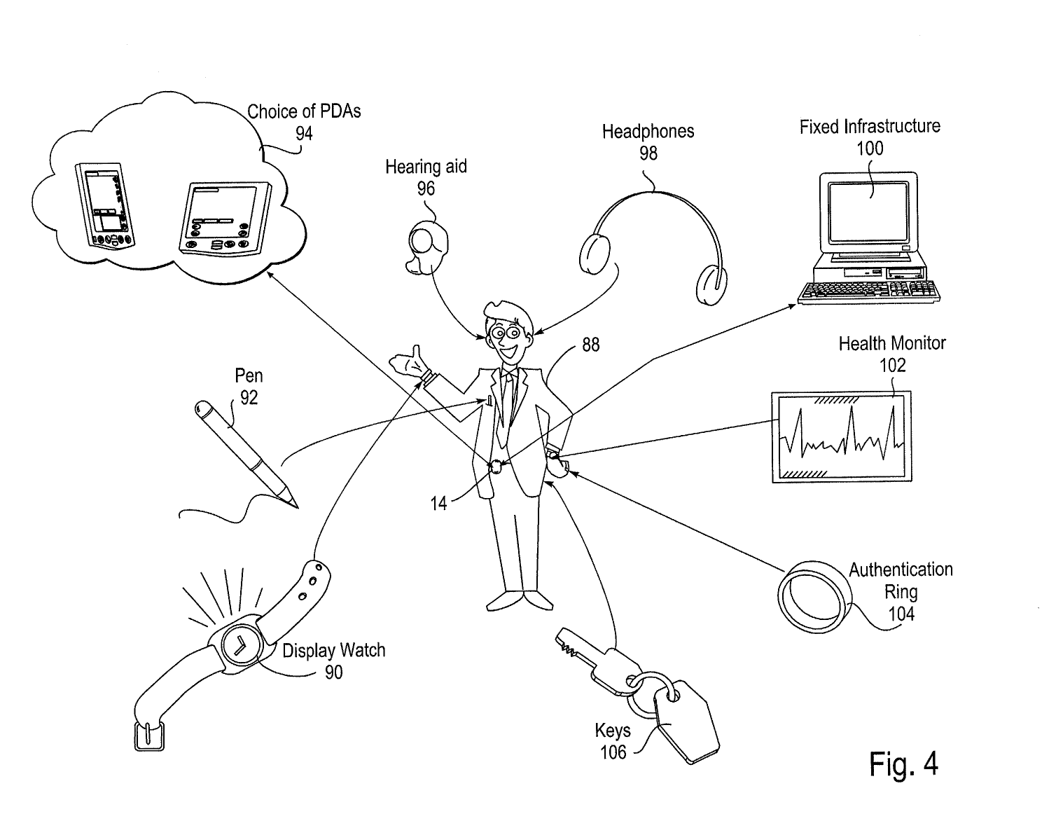

Referring in particular to FIG. 4 of the drawings, a variety of different access devices 12 are shown which, in combination with the portable memory device 14, provide a nomadic personal computing environment for a user 88 carrying the portable memory device 14. As the device 14 includes the wireless communication module 16, the user 88 may use a variety of different access devices to access the device 14. In particular, the access devices 12 optionally include a watch 90, a pen 92, a choice of personal digital assistants (PDAs) 94, a hearing aid 96, headphones 98, a PC 100, a health monitor 102, an authentication ring 106, and a key-holder 106. The type of access device 12 which the user 88 uses depends on the computing function which is required and the location or access point. The access devices 12 may be provided at a variety of different locations or access points, e.g., at a public kiosk at an airport, cafe, library, bank, or the like. For example, if data from the device 14 is in the form of MP 3 music files, the user may select the headphones 98 or the PC 100. If, however, the user 88 wishes to perform resource intense computing such as running an application program, the user may select the PC 100 only. If the user 88 wishes to access calendar and/or address book data, the PDAs 94 may be used. The device 14 may thus provide a central coordinating point for several wearable electronic interfaces, examples of which are listed above. When the device 14 interfaces with an access device 12 at a bank, e.g. an ATM or the like, the user interface may be tailored to suit the bearer of the device 14. For example, language settings, menu options, may be customized based on past transactions. In certain embodiments, the device 14 is arranged so as to personalize or configure a user's desktop PC with a customized theme and to provide links to applications used most frequently. The user's desktop PC may naturally also configure the device 14.

The portable device 14 need not include an integral user interface, but instead may utilize resident displays found in the local environment. When a more powerful access device is available, the limitations of the user interface of mobile devices may thus be overcome. The device 14, with its wireless communication module 16, allows an enabling interaction through whatever access device 12 is most convenient and appropriate without the need for an established network to gain access to personal data and/or applications. All the user's data and, optionally, application programs, may be carried around on the user's person and, since the device 14 does not include a keyboard and display, it can have a relatively small form factor. Further, the wireless communication module 16 allows interaction with a variety of different access devices without the need for hardwired cables and connection to a network thereby alleviating the problems associated with network connectivity and administration. Thus, limitations on network speed and security, issues surrounding connecting to a secure internet through a firewall, and their associated latency implications, may be avoided.

The personal server or device 14 may provide a user experience through an ad-hoc access device 12 based on resident and wearable interfaces. For example, the device 14 may provide the following functionality:

Convenient personal information (PIM) Access: Ubiquitous access to one's own personal information (e.g., calendar, contacts, or personal notes) through whatever interface is available (not necessarily owned by the user), be it a nearby PC, PDA, or wearable devices such as a watch.

Travelers Workstation: A “travelers workstation,” available anywhere a user travels, allowing access to personal/corporate data while visiting a client site. Additionally, by enabling access to large public/projected displays, presentations may be facilitated without dealing with cables and/or removable disks.

Content Creation: A central storage point enabling easy digital note creation. For example, a wearable electronically augmented broach could be used to capture quick voice notes, or a digital photograph, and store them locally on one's personal server defined by the device 14.

Vital Signs Monitoring: Pulse rate, respiratory rate, body temperature, and blood pressure monitored and recorded to enable specific health monitoring for people with chronic diseases or general fitness accounting.

Secure Transactions: Physically trusted wearable interfaces providing secure transactions with local resources. For example, a person bearing a device 14 could walk up to a public kiosk and order a copy of a book to be shipped home; corroborating the price and confirming the purchase on a trusted interface, such as a digital watch.

Intelligent Notification: An active gate for incoming notifications, such as phone calls or local advertising broadcasts, filtering out calls based on the users context (e.g., a meeting, home, or office) and notification of product availability (e.g., CDs on wish-list, children's toys).

Serendipitous Information Capture: Automatically capturing context information for serendipitous use later on. For instance, continuously capturing a users location would enable document retrieval based on the location that the document was created, or last edited.

In order to define a resident display for the device 14, the access device 12 typically includes a software adaptation layer that enables access device 12 to act as a client in support of the personal server or device 14. Additionally, the access device 12 typically provides access to various local resources, such as a printer, telephone, or the like. The adaptation layer is preferably deployed on a large number of potential hosts with a variety of basic interfaces (e.g., public displays, desktop systems, and PDAs) and other local resources (e.g., printers, computation, and wired network connections). When the user is in proximity to the access device 12, the adaptation layer automatically detects its presence, and the user can perform comprehensive computing functions based on the data and applications resident on the device 14 without the need to make any physical connections or access data from a remote source.

As mentioned above, the complexity or level of computing executed by the device 14 is dependent upon the type of access device 12 within its proximity. Examples of various applications are set out below.

Low-Level Graphics Primitives: For impoverished clients, such as existing PDAs, applications may be executed on the personal server or device 14 which may then transmit low-level graphic primitives straight to the client device or access device 12, allowing the execution of complex applications that would otherwise be limited by client or PDA processing.

Browser Metaphor: The device 14 may rendering text and images locally on the client or access device 12 that utilize the virtually ubiquitous HTML browser infrastructure, facilitating the use of the device 14 with systems or access devices that already support the common activity of web browsing.

Client Hosted Applications: Common applications, such as spreadsheets and word processors, can be found on many installed systems—providing rich interaction that merely requires the underlying data file to be transferred between the access device 12 and the device 14.

Mobile Code: The device 12 may include applications specifically designed for the personal server environment.

The invention, as illustrated, thus provides a portable bulk storage memory device 14 which defines a portable personal server that can automatically communicate with a variety of different access devices 12 in a wireless fashion. The portable memory device 14 may function as a second or alternative hard disk or bulk storage media so that the user effectively carries all his data and, optionally, application programs on his or her person. When the user approaches an appropriately enabled access device 12, the portable device 14 automatically establishes communications with the interface 12 to provide a computing environment to the user including components which the user need not own. The device 14 may thus function as a portable personal server which communicates with any one of a plurality of access devices when in proximity to the access devices. The device 14 may then effectively take over operation of the access device or a part of it (e.g., a window or any other partition on the interface) so that it acts as a slave to the personal memory device 14.

What is claimed is:

1. A portable memory device including:
a wireless communication module to communicate with an access device in a wireless fashion;
a data storage module to store bulk data; and
a controller connected to the communication module and to the data storage module, the controller controlling storage of data in the data storage module and retrieval of data from the data storage module in response to requests from a user via the access device.

2. A device as claimed in claim 1, in which the communication module is a radio frequency (RF) transceiver.

3. A device as claimed in claim 2, in which the wireless communication module communicates using a standardized communication protocol.

4. A device as claimed in claim 2, in which the communication module communicates using Bluetooth IEEE 802.15 technology.

5. A device as claimed in claim 4, in which the communication module includes Bluetooth hardware interacting with a Bluetooth software stack.

6. A device as claimed in claim 5, in which the controller includes a host control interface (HCI) to interface the controller to the wireless communication module in a serial fashion.

7. A device as claimed in claim 6, in which the HCI is a USB interface.

8. A device as claimed in claim 1, in which the controller includes a processor which operates in at least two different modes dependent upon processing power requirements.

9. A device as claimed in claim 8, in which the processor operates in at least a first and a second active mode, the processor being configured to have greater processing capabilities when in the second active mode.

10. A device as claimed in claim 1, in which the communication module operates in a dormant mode when not communicating with the access device, and in an active mode when communicating with the access device.

11. A device as claimed claim 8, in which the clock frequency of the processor is adjusted when the processor is in a different mode of operation.

12. A device as claimed in claim 11, in which the supply voltage to the processor is selectively reduced.

13. A device as claimed in claim 12, which includes a DVM module for adjusting the processor voltage dependent upon its mode of operation.

14. A device as claimed in claim 1, which includes a rechargeable power supply for powering its various components, and a display to form a self-contained functional unit when not used in conjunction with the access device.

15. A data processing system, which includes:
a plurality of access devices, each access device including at least a wireless communication interface; and
at least one portable memory device which includes
a wireless communication module to communicate in a wireless fashion with the wireless communication interface of any one of the access devices when in proximity to the access device;
a data storage interface connected to a data storage module; and
a controller connected to the communication module and to the data storage interface, the controller controlling storage of data in the data storage module and retrieval of data from the data storage module in response to requests from a user via any one of the access devices.

16. A system as claimed in claim 15, in which the portable memory device communicates data stored in the data storage module exclusively via the access device.

17. A system as claimed in claim 15, in which the data storage module is releasably connected to the data storage interface to allow a user to store and retrieve data from a connected data storage module via the access device in a wireless fashion.

18. A system as claimed in claim 15, in which the data storage module forms an integral part of the portable device, the device including a compact portable housing for housing its various components and modules.

19. A system as claimed in claim 18, in which the portable device includes a power source including an attachment arrangement releasably to attach a power source to a complemental attachment arrangement of the housing.

20. A system as claimed in claim 19, in which the power source is a rechargeable battery source and the portable device includes a charger circuit for charging the battery without removing it from the housing.

21. A system as claimed in claim 15, in which the data storage module is a semiconductor memory selected from the group including a FLASH memory, DRAM memory and SRAM memory.

22. A system as claimed in claim 15, in which the data storage module is a magnetic memory device in the form of a disk drive.

23. A system as claimed in claim 15, in which the data storage module is an optical storage device.

24. A wireless interface including:
a wireless communication module to communicate with an access device in a wireless fashion;
a connector to connect to a data storage module which operatively stores bulk data; and
a controller connected to the communications module and to the connector, the controller controlling the storage of data in the data storage module and the retrieval of data from the data storage module in response to requests from a user via the access device.

25. A wireless interface as claimed in claim 24, in which the communication module is a radio frequency (RF) transceiver.

26. A wireless interface as claimed in claim 25, in which the wireless communication module communicates using a standardized communication protocol.

27. A wireless interface as claimed in claim 25, in which the communication module communicates using Bluetooth IEEE 802.15 technology.

28. A method including:
providing a portable memory device which includes a wireless communication module;
sensing when the memory device is in proximity to any one of a plurality of access devices;
establishing wireless communication with the access device; and
communicating data between the memory device and the access device which operatively displays the data to a user.

29. A method as claimed in claim 28, which includes determining the processing capabilities of the access device and adjusting a level of processing by a processor of the portable memory device dependent upon the processing capabilities of the access device.

30. A method as claimed in claim 29, which includes running application software on the portable memory device when the device has a greater processing capability than the access device.

31. A method as claimed in claim 30, which includes running application software on the access device when the access device has sufficient processing capabilities, and storing data in and retrieving data from the portable memory device as required by the application software.

32. A method as claimed in claim 29, which includes operating a processor of the portable memory device in at least two different modes dependent upon processing power requirements of the device.

33. A method as claimed in claim 32, which includes operating the processor in at least a first and a second active mode, the processor being configured to have greater processing capabilities when in the second active mode.

34. A method as claimed in claim 28, in which the processor is switched into different a different mode of operation by adjusting its supply voltage.

35. A method as claimed in claim 28, in which the communication module operates in a dormant mode in which its power consumption is reduced when not communicating with the access device, and in an active mode when communicating with the access device.

36. A method as claimed in claim 35, which includes adjusting the processor voltage dependent upon the required mode of operation.

37. A method as claimed claims 35, which includes adjusting the clock frequency of the processor when the processor is in a different mode of operation.
